(19) United States
(12) Patent Application Publication
(10) Pub. No.: US 2007/0067744 A1
(43) Pub. Date: Mar. 22, 2007

(54) System and method for the anticipation and execution of icon selection in graphical user interfaces

(76) Inventors: David M. Lane, Houston, TX (US); H. Albert Napier, Fredericksburg, TX (US); S. Camille Peres, Taylor Lake Village, TX (US); Aniko Sandor, Houston, TX (US)

Correspondence Address: Roger Fulghum;Baker Botts L.L.P., One Shell Plaza, 910 Louisiana Street, Houston, TX, 77002-4995, US

(21) Appl. No.: 11/503,516

(22) Filed: Aug. 11, 2006

Related U.S. Application Data
(60) Provisional application No. 60/707,400, filed on Aug. 11, 2005.

(51) Int. Cl. G06F 17/00

(52) U.S. Cl. 715/860; 715/861; 715/812

(57) ABSTRACT

A process for anticipating and executing icon selection in graphical user interfaces is disclosed. In accordance with one aspect of the present invention, a method is provided for selecting an icon in a graphical user interface based on the movement of a cursor and the history of a user's icon selection, allowing the user to confirm the selection of the icon for execution without moving the cursor to the icon to select the icon

### CROSS-REFERENCE TO RELATED APPLICATIONS

This application claims the benefit of U.S. provisional patent application Ser. No. 60/707,400, titled “A Process for Anticipating and Executing Icon Selection in Graphical User Interfaces” by David M. Lane, et al., which was filed on Aug. 11, 2005 and which is incorporated herein by reference in its entirety for all purposes.

### TECHNICAL FIELD

The present disclosure relates generally to icon-selection and, more particularly, to a method for selecting an icon in a graphical user interface.

### BACKGROUND

Recently, the use of icon toolbars has become popular, surpassing, for some users, the use of pull-down menus and keyboard shortcuts. The use of icon toolbars, however, is not currently as efficient as the use of keyboard shortcuts. Additionally, with the increasing size of display screens, the distance that a cursor must traverse to reach an icon toolbar will also increase. Therefore, the time to reach an icon toolbar will increase as well. To avoid this loss in efficiency, software trainers often endorse the use of keyboard shortcuts over the use of icon toolbars. However, due to the ease of use of icon toolbars relative to the difficulty of memorizing keyboard shortcuts, this approach is unlikely to have a significant effect on increasing user efficiency.

### SUMMARY

In accordance with the present disclosure, a process for anticipating and executing icon selection in graphical user interfaces is provided which substantially reduces disadvantages associated with previous systems and methods. In accordance with one aspect of the present invention, a method is provided for selecting an icon in a graphical user interface based on the movement of a cursor and the history of a user's icon selection, allowing the user to confirm the selection of the icon for execution without the cursor being in the vicinity of the icon.

The method disclosed herein is technically advantageous because it provides a method for selecting an icon in a graphical user interface that improves the efficiency of using an icon toolbar while preserving the ease of use of an icon toolbar. The disclosed method reduces the time and effort required to select an icon from an icon toolbar. The advantages of the disclosed method are especially evident to users of computer laptops and other devices that use trackpads as pointing devices, as the user can select and activate the function associated with the icon without the cursor being in the vicinity of the icon. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a logical diagram illustrating the logical architecture of a computer system that includes icon prediction system software;

FIG. 2 is a first example of the operation of an icon prediction system a graphical user interface;

FIG. 3 is a second example of the operation of the icon prediction system in a graphical user interface having cursor movement;

FIG. 4 is a third example of the operation of the icon prediction system in a graphical user interface having additional cursor movement;

FIG. 5 is a flow diagram of a method for predicting and selecting an icon; and

FIG. 6 is an example of a pointing device;

### DETAILED DESCRIPTION

This disclosure details a method for predicting the icon a user will select from an icon toolbar in a graphical user interface based on data such as command usage frequency and cursor trajectory, and subsequently highlighting the icon for the software user to verify and select. It should be noted that the prediction method does not execute any actions independently. Rather, the method anticipates where the user's cursor is headed, highlights an icon which the user may then verify and select as the desired icon, and allows for the execution of the verified icon by the user. This is all accomplished by the method despite the fact that the cursor may not be in the vicinity of the predicted icon at the time of the prediction and selection of the icon. Thus, the user may select and activate the function or command of a predicted icon, even if the cursor is not over or near the selected icon.

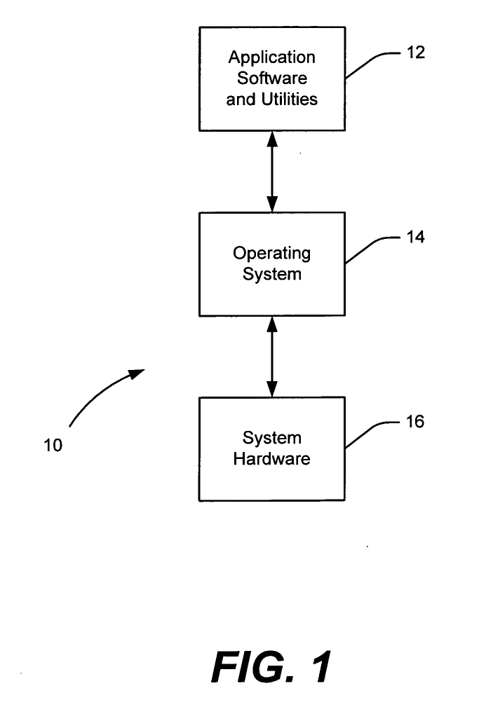

FIG. 1 is a logical diagram illustrating a computer system 10. The computer system's hardware 16 communicates with the operating system 14, which in turn communicates with and manages various applications' software and utilities 12. Application software resides in block 12. An icon prediction method, to be used in conjunction with the graphical user interface of an application's software, is an example of a software utility hosted by the computer's operating system.

In some circumstances, in order to provide an efficient method for icon selection, a limited prediction method for icon prediction and selection may be employed. In the limited prediction embodiment of the present disclosure, the method only attempts to predict and highlight certain icons in the icon toolbar of the graphical user interface. This means that the icon prediction and selection method of the present disclosure may only be active for a subset of icons in the icon toolbar. This embodiment is useful because, typically, a user tends to select and execute relatively few icons in an application. Thus, having a limited prediction method avoids the extra computational load and potentially lower accuracy of a full-prediction method (in which the method is active for all icons in the application) in these circumstances, while allowing the user to benefit from the prediction and selection methods for the most commonly used icons. It should be noted, however, that a full-prediction system, in which all of the icons in the icon toolbar are members of the set of selectable icons, may be more efficient or better suited in different circumstances, depending on the number of icons at issue, the processing power of the computer system and the needs of the user of the computer system.

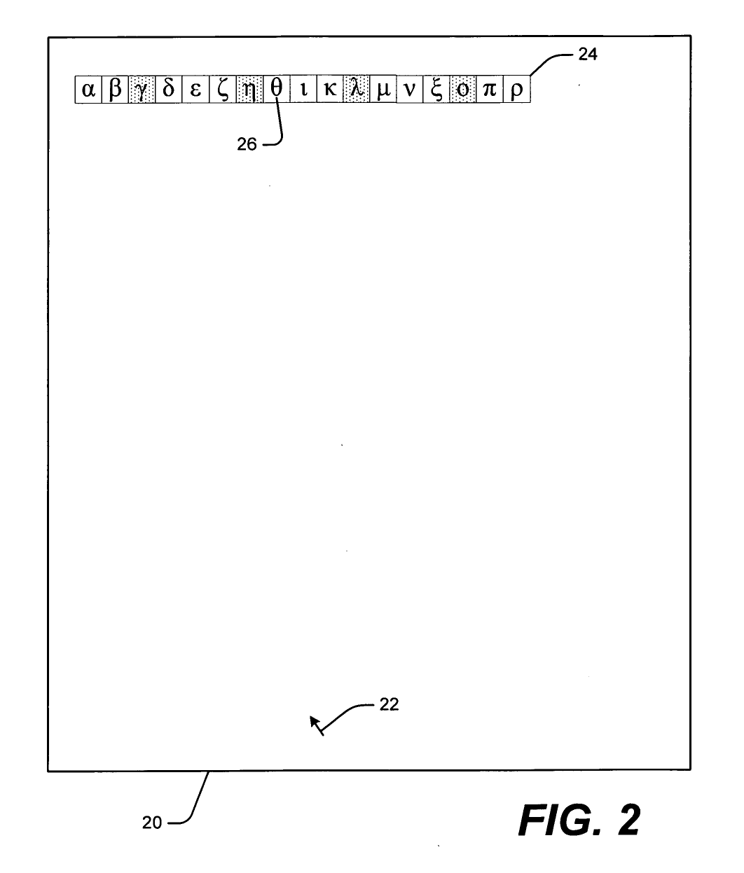

In FIG. 2, an example of the icon-prediction method is illustrated. The figure is a screen shot 20 of an application with a graphical user interface using the icon-prediction method of the present disclosure. The figure shows an arrow-shaped cursor 22 and an icon toolbar 24 containing several icons, each like icon 26. The limited prediction embodiment of the method is in use in this illustration. The set of predictable icons in this example are visually marked with shading such that the user knows which icons are selectable by the remote selection and prediction method disclosed herein and which icons are not and must therefore be hand-selected by using a standard method such as moving the cursor to the icon and clicking a button on the pointing device.

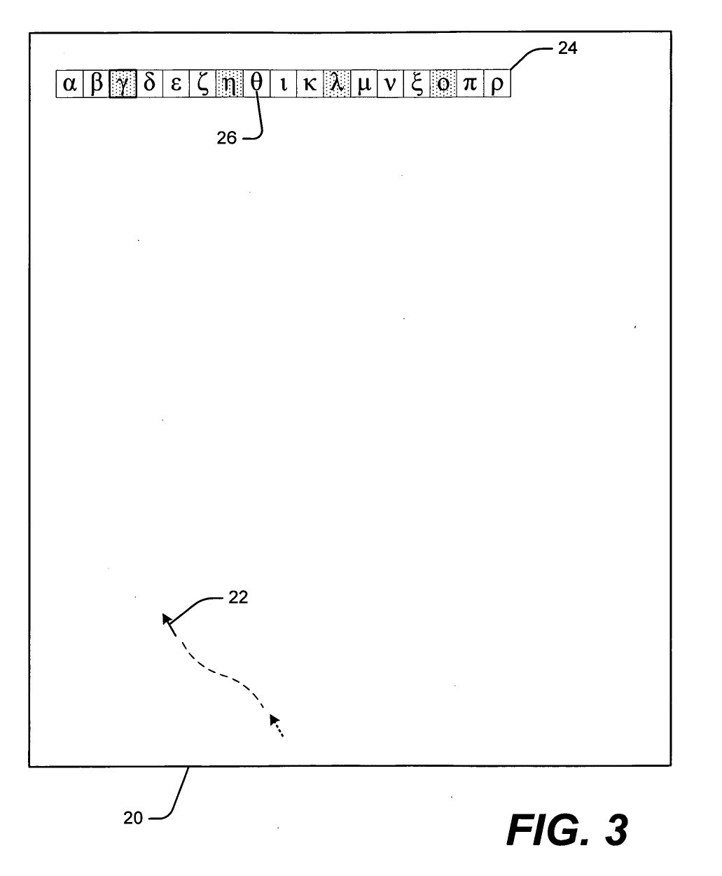

In FIG. 3, the screen shot of FIG. 2 is shown, but the cursor 22 has now moved to a new location, the movement indicated by the dashed line. The new position of the cursor is indicated by a black arrow, and the old position is indicated by a dashed arrow. Additionally, predictable icon γ has a black box around it, indicating that the method has predicted that icon as the user's desired icon based, in part, on the direction of the movement of the cursor. The highlighting of the icon γ is based on the movement of the cursor in the direction of icon γ. At this point, if the user were to activate a designated pointing device, icon γ would be selected, even though the cursor is not in the vicinity of icon γ.

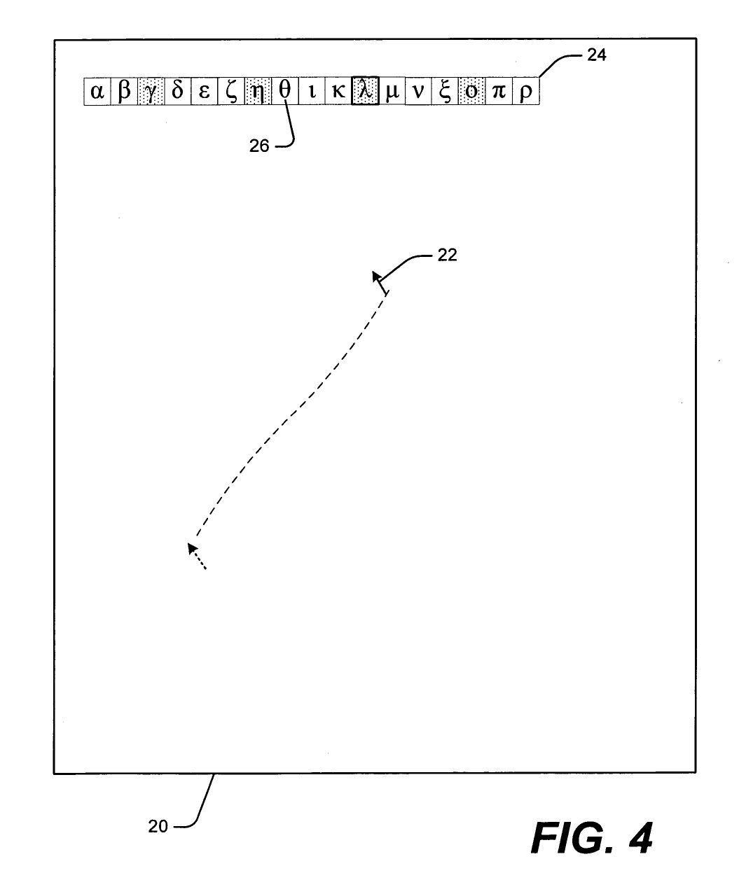

In FIG. 4, the screen shot FIGS. 2 and 3 is shown, but the cursor 22 has again moved to a new location. It is assumed that the user has not selected the icon γ that the method predicted in the FIG. 3. Instead, the user has continued moving the cursor toward the icon toolbar 24, and the method has revised its prediction of which icon the user desires. In this example, based at least in part on the movement of the cursor, the method has predicted that icon λ is the user's desired icon, indicated by the black box around icon B. At this point, if the user were to activate a designated pointing device, icon λ would be selected, even though the cursor is not in the vicinity of icon λ.

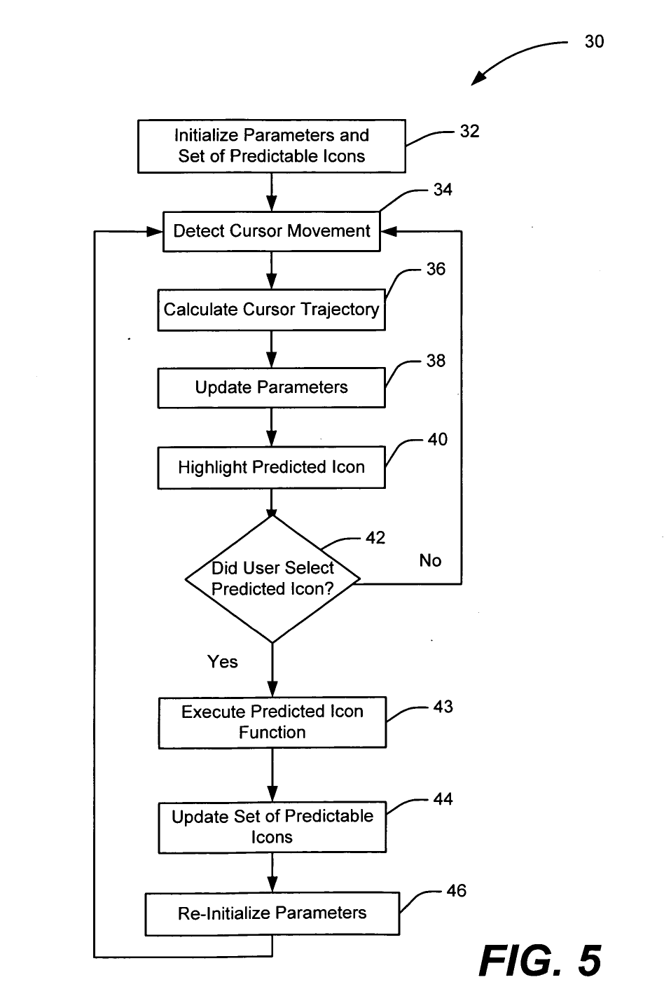

FIG. 5 is a flow diagram showing the steps 30 used by the method to predict which icon in an icon toolbar is a user's desired icon. Initially, in step 32, the method determines a set of predictable icons and assign each of the icons in the set a parameter value which is updated throughout the course of operation of the method. When the cursor is moved by the user, the movement is detected in step 34, and the method then calculates the cursor's trajectory and compares this information to the location of each of the predictable icons in the icon toolbar in step 36. Based on the trajectory information and the old parameter values assigned to each predictable icon, the method updates the parameter values of each of the predictable icons in step 38. The method then chooses and highlights one of the predictable icons as the predicted icon based on the new parameter values in step 40. In one embodiment, this choice is made by choosing the predictable icon with the largest parameter value (explained below). Once an icon is highlighted as the predicted icon, denoted with a black box around the icon in the screen shots in the figures, the method notes whether the user selects the predicted icon or not in step 42. The user may select the predicted icon in any of a number of ways to be detailed below, including the click of a button on a pointing device. If the user does select the predicted icon, the method then executes the function or command associated with the predicted icon in step 43, updates the set of predictable icons in step 44, re-initializes the parameter values for each of the newly predictable icons in step 46, and waits for the cursor's next movement, returning to step 34.

If instead, the user does not select an icon, the method waits for the cursor's next movement, returning to step 34, and repeats the process. It should be noted that, in this second case, because the parameters and set of predictable icons have not been re-initialized, the next set of calculations is based upon the current values of the parameters. In another embodiment, however, it is possible that certain parameters would be updated even when the user does not select an icon. It should also be noted that a user may execute a command associated with an icon which is outside of the set of predictable icons by moving the cursor all the way to the icon and selecting the icon in the conventional manner (such as a click of the left mouse button). If the user does select an icon which is outside of the set of predictable icons, the flow of actions in FIG. 5 remains the same as if the user had selected the predicted icon: The function associated with the selected icon is executed, the set of predictable icons is updated (in some embodiments, to include this most recently selected icon), the parameters for the icons in the set of predictable icons are re-initialized, and the method again waits for the cursor's next movement. Additionally, if the full-prediction method is in use, the flow diagram of FIG. 5 also does not change, as the set of predictable icons would simply be the set of all icons in the icon toolbar of the graphical user interface. It should be appreciated that, when all of the icons are selectable, the steps associated with establishing or manipulating a subset of predictable icons are not performed. Rather, all icons are considered to be selectable and there is no need to identify which icons are in the set of selectable icons.

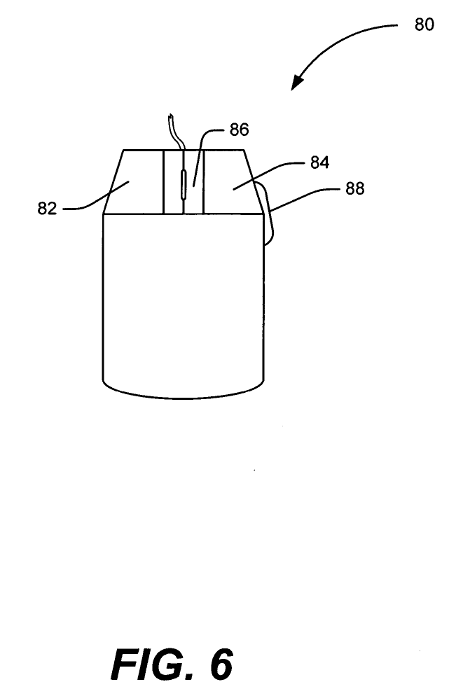

Although the method disclosed herein may employ a left click of the mouse or other pointing device to “click-on” or activate the function or command associated with the icon, it should be recognized that the invention disclosed herein may be used with pointing devices other than mouse pointing devices. With respect to a mouse pointing device, one of the programmable buttons on the mouse could be designated as being the button associated with the selection of the function associated with the currently predicted icon. An example of a mouse pointing device is illustrated in FIG. 6. In this figure, a multi-button mouse 80 is shown. The mouse has a left button 82, a right button 84, a middle button or scroll wheel 86, and a side button 88. Any of these buttons may be designated (depending on the mouse and software available) as the button associated with the selection of the predicted icon, such that, when the user activates the designated button, the function of the currently predicted icon is activated, even if the cursor is not in the vicinity of the predicted icon. In addition to the use of a mouse, another external pointing device could be a trackpad of a laptop computer. Some trackpads include a programmable middle button between the left and right mouse buttons below the trackpad which, for example, could be used as the designated selection button or activator. In another instance, an external device such as a voice command device, foot pedal, or keyboard could be used to “click-on” the icon predicted.

The algorithm used for predicting the user's desired icon may be one of any number of algorithms which perform the general steps outlined in FIG. 5. An example of an icon prediction algorithm is set out below. The set of predictable icons is determined in part by the prior probability for each icon that it is the icon the user intends to select. Additionally, each icon in the set of predictable icons is initially assigned a value Vᵢ related to this prior probability. The Vs, however, are not true probabilities themselves, but the initial value of each Vs can indicate the relative frequency with which that icon has been previously selected, and as the algorithm progresses, the values of the Vᵢs may be thought of as pseudo probabilities. The actual prior probability that an icon is the icon the user intends to select can be calculated from previous data on typical users or from data collected on the individual user in question. The calculation of this prior probability may involve the frequency with which an icon is used, the time elapsed since an icon was last used, the position of an icon's selection in a sequence of icon selections, or a history of commands for the user in question. It should be noted that in the case where these prior probabilities are calculated from data collected on the individual user in question, the probabilities may be dynamically updated based on the user's past actions. Since the set of predictable icons is determined in part by the prior probabilities, dynamically updating these probabilities may affect which icons are members of the set of predictable icons during each update of the set. For example, the last icon selected by the user could automatically become a member of this set. Additionally, the initial values of the Vᵢs are related to these prior probabilities as well. Thus, when a user selects any icon, whether it is in the set of predictable icons or not, the set of predictable icons and their corresponding V parameters are updated.

As the user moves the cursor towards the icon toolbar, the method dynamically revises its assessment of the predicated icon based in part on the cursor's trajectory information. The trajectory information of the cursor is incorporated into the Vs as the Vs are updated every time the cursor moves a distance of d pixels. The Vs are updated as follows: Define pᵢ as the proportion of the distance the cursor has traveled to icon i since the last update. Define Vᵢⱼ as the parameter value for icon i after update j. If icon i is not currently the predicted icon then:
Vᵢⱼ₊₁=Vᵢⱼpᵢ
If icon i is currently the predicted icon, then the updated parameter value is:
Vᵢⱼ₊₁=kVᵢⱼpᵢ
where k is a number less than 1. The k parameter is a means of reflecting the fact that the user did not select the predicted icon, thus implying that it is less likely to be the desired target icon than previously thought. The new value of the predicted but not selected icon is thus lower because of k, reflecting this knowledge. After the Vs are updated, the icon in the set of predictable icons with the highest V is highlighted as the predicted command. When the cursor continues to move, the prediction method remains active, and the predicted icon is continually updated and indicated visually as the cursor is moved toward the icon toolbar.

If the user wishes to execute the command associated with the predicted icon, he or she may push a button on a mouse or other pointing device, for example. As such, the command associated with the predicted icon can be executed without the necessity of the cursor being located over the predicted icon.

There are certain parameter values associated with the example algorithm detailed above. Shown in Table 1 is an example set of these parameter values:

TABLE 1

| Parameter | Description | Value |
|---|---|---|
| d | Distance in pixels the cursor must move before the | 25 |
| | Vs are updated | |
| k | Used to reduce the value of an icon that is currently | 0.9 |
| | highlighted but not selected by the user | |
| q | Number of milliseconds after the predicted icon | 200 |
| | changes before any response is considered | |
| | confirmation of the newly predicted icon | |
| t | The amount of time before the predicted icon can | 0 |
| | change | |

Because it may possibly confuse the user if the predicted icon changes too rapidly, the predicted icon may not change until at least t milliseconds have passed after its prediction. Additionally, an error may occur if the user decides to select a predicted icon but the predicted icon changes before the user has a chance to verify the prediction and select the icon. Therefore, any user selection occurring fewer than q milliseconds after the predicted icon changes is considered a verification of the previously predicted icon.

In another additional embodiment of the method, the method attempts to determine whether the user is in a “lateral move mode” by considering how close to a horizontal direction the cursor is moving. When the method judges that the user is in this mode, meaning that the user is moving in a relatively horizontal direction, the method changes the highlighted icon horizontally one icon at a time.

The selection of an icon according to the system and method disclosed herein may be based on any combination of factors. These factors may include trajectory, history, and frequency. As such, the prediction system may rely on trajectory alone, to the exclusion of history or frequency factors. Alternatively, as another example, the prediction system may make an icon prediction on the basis of the combination of trajectory and history factors, taking into account the trajectory of the cursor as well as the user or a typical user's history of selecting icons over a defined period. As another example, the icon prediction system may make an icon prediction on the basis of trajectory and frequency factors, taking into account both the trajectory of the cursor and the most recently selected icons. As another example, the icon prediction system may make an icon prediction solely on the basis of history and/or frequency. As such, it should be understood that a number of prediction models may be employed herein, each of which predicts an icon and allows for the selection of the icon, despite the cursor not being in the vicinity of the icon at the time of the selection of the icon and the activation of the function associated with the icon.

Icons may be spaced in any spatial setup which is compatible with the graphical user interface, software, and hardware being employed. Although the present disclosure details icons located in a toolbar, the spatial setup of the icon toolbar is not limited to the embodiments disclosed herein. In addition, the system and method disclosed herein may be used with any spatial arrangement of icons in a graphical user interface, and is not limited in its application to icons located in a toolbar. Although the present disclosure has been described in detail, it should be understood that various changes, substitutions, and alterations can be made hereto without departing from the spirit and the scope of the invention as defined by the appended claims.

What is claimed is:

1. A method for selecting an icon in a graphical user interface, comprising the steps of:
monitoring the movement of a cursor in the graphical user interface;
selecting an icon in the graphical user interface on the basis of an analysis of the movement of the cursor in the graphical user interface and the history of icon selection in the graphical user interface;
confirming the selection of the icon through an external pointing device, wherein the step of confirming the selection of the icon is performed without the necessity of moving the cursor in the vicinity of the icon in the graphical user interface.

2. The method for selecting an icon in a graphical user interface of claim 1, wherein the step of selecting an icon occurs periodically based on the movement of the cursor.

3. The method for selecting an icon in a graphical user interface of claim 1, wherein the external pointing device is equipped with at least one button and wherein the step of confirming the selection of the icon is performed by clicking the button on the pointing device.

4. The method for selecting an icon in a graphical user interface of claim 1, wherein the analysis of the movement of the cursor in the graphical user interface is conducted over a period of time.

5. The method for selecting an icon in a graphical user interface of claim 1, wherein the analysis of the movement of the cursor in the graphical user interface is conducted instantaneously.

6. The method for selecting an icon in a graphical user interface of claim 1, wherein the analysis of the movement of the cursor in the graphical user interface includes the calculation of an angle between at least two vectors, wherein each vector connects at least two pixels.

7. The method for selecting an icon in a graphical user interface of claim 1, additionally comprising:
determining whether the cursor is in a lateral move mode; and
changing the selected icon horizontally one icon at a time if the cursor is in a lateral move mode.

8. A method for selecting an icon in a graphical user interface, comprising the steps of:
identifying a set of predictable icons;
monitoring the movement of a cursor in the graphical user interface;
selecting an icon from the set of predictable icons in the graphical user interface on the basis of an analysis of the movement of the cursor in the graphical user interface and the history of icon selection in the graphical user interface;
confirming the selection of the icon through an external pointing device, wherein the step of confirming the selection of the icon is performed without the necessity of moving the cursor in the vicinity of the icon in the graphical user interface.

9. The method for selecting an icon in a graphical user interface of claim 8, wherein the step of selecting an icon occurs periodically based on the movement of the cursor.

10. The method for selecting an icon in a graphical user interface of claim 8, wherein the external pointing device is equipped with at least one button and wherein the step of confirming the selection of the icon is performed by clicking the button on the pointing device.

11. The method for selecting an icon in a graphical user interface of claim 8, wherein the analysis of the movement of the cursor in the graphical user interface is conducted over a period of time.

12. The method for selecting an icon in a graphical user interface of claim 8, wherein the analysis of the movement of the cursor in the graphical user interface is conducted instantaneously.

13. The method for selecting an icon in a graphical user interface of claim 8, wherein the analysis of the movement of the cursor in the graphical user interface includes the calculation of an angle between at least two vectors, wherein each vector connects at least two pixels.

14. The method for selecting an icon in a graphical user interface of claim 8, additionally comprising:
determining whether the cursor is in a lateral move mode; and
changing the selected icon horizontally one icon at a time if the cursor is in a lateral move mode.

15. The method for selecting an icon in a graphical user interface of claim 8, additionally comprising updating the set of predictable icons.

16. A method for selecting an icon in a graphical user interface, comprising the steps of:
monitoring the movement of a cursor in the graphical user interface;
selecting an icon in the graphical user interface on the basis of an analysis of the movement of the cursor in the graphical user interface;
confirming the selection of the icon through an external pointing device, wherein the step of confirming the selection of the icon is performed without the necessity of moving the cursor in the vicinity of the icon in the graphical user interface.

17. The method for selecting an icon in a graphical user interface of claim 16, wherein the step of selecting an icon occurs periodically based on the movement of the cursor.

18. The method for selecting an icon in a graphical user interface of claim 16, wherein the external pointing device is equipped with at least one button and wherein the step of confirming the selection of the icon is performed by clicking the button on the pointing device.

19. The method for selecting an icon in a graphical user interface of claim 16, wherein the analysis of the movement of the cursor in the graphical user interface is conducted over a period of time.

20. The method for selecting an icon in a graphical user interface of claim 16, wherein the analysis of the movement of the cursor in the graphical user interface includes the calculation of an angle between at least two vectors, wherein each vector connects at least two pixels.
